(19) United States
(12) Patent Application Publication
(10) Pub. No.: US 2023/0094137 A1
(43) Pub. Date: Mar. 30, 2023

(54) GENERATING AND VISUALIZING A DATA STRUCTURE OF A MANAGEMENT MODEL OF AN APPLICATION SERVER

(71) Applicant: Red Hat, Inc., Raleigh, NC (US)

(72) Inventor: Harald Pehl, Grasbrunn (DE)

(21) Appl. No.: 17/484,808

(22) Filed: Sep. 24, 2021

(51) Int. Cl. G06F 16/28; G06F 16/21; G06F 16/901

(52) U.S. Cl. CPC G06F 16/287; G06F 16/219; G06F 16/9024

(57) ABSTRACT

Generating and visualizing a data structure for a management model of an application server is provided herein. In particular, a computing system obtains, from an executing application server, a first version of a management model comprising a plurality of resources. A set of the plurality of resources comprising a key identifying a resource type, a value identifying a resource name for the resource type, and an address identifying a path from a root resource of a resource tree. The computing system stores, in a first version data structure, a plurality of resource node records, each of the plurality of resource node records corresponding to a different one of the plurality of resources. The computing system stores, in the first version data structure, a plurality of edge records, at least a portion of the plurality of edge records identifying a relationship between resource node records.

### BACKGROUND

Application servers are increasingly used to simplify application development, to facilitate application distribution, for scalability purposes, and for a variety of other reasons.

### SUMMARY

The examples disclosed herein provide generating and visualizing a data structure of a management model of an application server. In particular, a computing system including one or more processor devices of one or more computing devices obtains from an executing application server configured to provide one or more services to a plurality of applications, each application being configured to interface with the application server to obtain the one or more services, a first version of a management model comprising a first plurality of resources. The first plurality of resources includes configuration parameters used by the application server to provide at least some of the services to the plurality of applications, and includes first relationship information that identifies relationships among the first plurality of resources. A set of the first plurality of resources includes a key identifying a resource type, a value identifying a resource name for the resource type, and an address identifying a path from a root resource of a resource tree. A set of the first plurality of resources is capable of implementing an operation comprising a parameter. The computing system stores, in a first version data structure, a first plurality of resource node records, each of the first plurality of resource node records corresponding to a different one of the first plurality of resources. The computing system stores, in the first version data structure, a first plurality of edge records, at least a portion of the first plurality of edge records identifying a relationship between resource node records.

In one example, a method is provided. The method includes obtaining, by a computing system comprising one or more processor devices of one or more computing devices, from an executing application server configured to provide one or more services to a plurality of applications, each application being configured to interface with the application server to obtain the one or more services, a first version of a management model comprising a first plurality of resources. The first plurality of resources includes configuration parameters used by the application server to provide at least some of the services to the plurality of applications, and includes first relationship information that identifies relationships among the first plurality of resources. A set of the first plurality of resources includes a key identifying a resource type, a value identifying a resource name for the resource type, and an address identifying a path from a root resource of a resource tree. A set of the first plurality of resources is capable of implementing an operation comprising a parameter. The method further includes storing, in a first version data structure, a first plurality of resource node records, each of the first plurality of resource node records corresponding to a different one of the first plurality of resources. The method further includes storing, in the first version data structure, a first plurality of edge records, at least a portion of the first plurality of edge records identifying a relationship between resource node records.

In another implementation, a computing system is disclosed. The computing system includes one or more processor devices of one or more computing devices obtaining, from an executing application server configured to provide one or more services to a plurality of applications, each application being configured to interface with the application server to obtain the one or more services, a first version of a management model comprising a first plurality of resources. The first plurality of resources includes configuration parameters used by the application server to provide at least some of the services to the plurality of applications, and includes first relationship information that identifies relationships among the first plurality of resources. A set of the first plurality of resources includes a key identifying a resource type, a value identifying a resource name for the resource type, and an address identifying a path from a root resource of a resource tree. A set of the first plurality of resources is capable of implementing an operation comprising a parameter. The one or more processor devices of the one or more computing devices further stores, in a first version data structure, a first plurality of resource node records, each of the first plurality of resource node records corresponding to a different one of the first plurality of resources. The one or more processor devices of the one or more computing devices further stores, in the first version data structure, a first plurality of edge records, at least a portion of the first plurality of edge records identifying a relationship between resource node records.

In another implementation, a computer program product is disclosed. The computer program product is stored on a non-transitory computer-readable storage medium and includes instructions to cause one or more processor devices of one or more computing devices to obtain, from an executing application server being configured to provide one or more services to a plurality of applications, each application being configured to interface with the application server to obtain the one or more services, a first version of a management model comprising a first plurality of resources. The first plurality of resources includes configuration parameters used by the application server to provide at least some of the services to the plurality of applications, and includes first relationship information that identifies relationships among the first plurality of resources. A set of the first plurality of resources comprises a key identifying a resource type, a value identifying a resource name for the resource type, and an address identifying a path from a root resource of a resource tree. A set of the first plurality of resources is capable of implementing an operation comprising a parameter. The instructions to cause the one or more processor devices of the one or more computing devices further include instructions to store, in a first version data structure, a first plurality of resource node records, each of the first plurality of resource node records corresponding to a different one of the first plurality of resources. The instructions to cause the one or more processor devices of the one or more computing devices further include instructions to store, in the first version data structure, a first plurality of edge records, at least a portion of the first plurality of edge records identifying a relationship between resource node records.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1A is a block diagram of a computing system to generate and use a data structure of a management model of an application server according to one example;

FIG. 1B is a diagram of a data structure embodied as a graph database of the computing system of FIG. 1A according to one example;

FIG. 2 is a flowchart of a method for generating a data structure for a management model of an application server according to one example;

FIG. 3 is a flowchart illustrating a method for generating a data structure for a management model of an application server according to one example;

FIG. 4 is a flowchart illustrating a method for generating capability nodes in the data structure according to one example;

FIG. 5 is a flowchart illustrating a method for generating attribute nodes in the data structure according to one example;

FIG. 6 is a flowchart illustrating a method for generating operation nodes and parameter nodes of the data structure according to one example;

FIG. 7A illustrates a graphical user interface (GUI) providing different WildFly versions and associated management model versions according to one example;

FIG. 7B illustrates a GUI providing a navigation of resources and corresponding features according to one example;

FIG. 7C illustrates a GUI providing text search functionality according to one example;

FIG. 7D illustrates a GUI providing deprecated attributes, operations, and/or resources associated with a particular version according to one example;

FIG. 7E illustrates a GUI providing differences between resources according to one example;

FIG. 8A is a flowchart illustrating accessing different versions of a management model according to one implementation;

FIG. 8B is a flowchart illustrating conducting a textual search request of a management model according to one implementation;

FIG. 8C is a flowchart illustrating comparing two different versions of a management model according to one implementation;

FIG. 9 is a simplified block diagram of the computing system illustrated in FIG. 1A according to one implementation; and

FIG. 10 is a block diagram of a computing device containing components suitable for implementing any of the processing devices disclosed herein.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B.

Application servers are increasingly used to simplify application development, to facilitate application distribution, for scalability purposes, and for a variety of other reasons.

Application servers, such as a WildFly application server, host and run applications, such as for testing and development. Application servers have a management model that includes components accessible to a user, such as a software developer, through an Application Programming Interface (API), which may be at least partially defined by the application server itself. Administrators often require a detailed understanding of the management model, including relationships between different elements of the management model. However, accessing the management model generally requires execution by the application server, such that the management model cannot be accessed separately from the application server. Further, oftentimes it is difficult to search and navigate the management model and/or ascertain differences between different versions of the management model, such as due to changed attributes and/or deprecated operations.

The examples disclosed herein provide generating and visualizing a data structure of a management model of an application server. A computing system obtains a version of a management model and then stores resource node records identifying a resource in a data structure and stores edge records identifying a relationship of the resource in the data structure. A different data structure is developed for each version of the management model. Accordingly, the computing system provides data structures independent from the application server. These data structures can be accessed to search the complete management model, illustrate relationships of resources, access to all versions of a management model from a single user interface (UI), compare different versions of the management model, and/or can compare different versions of resources between different versions of the management models.

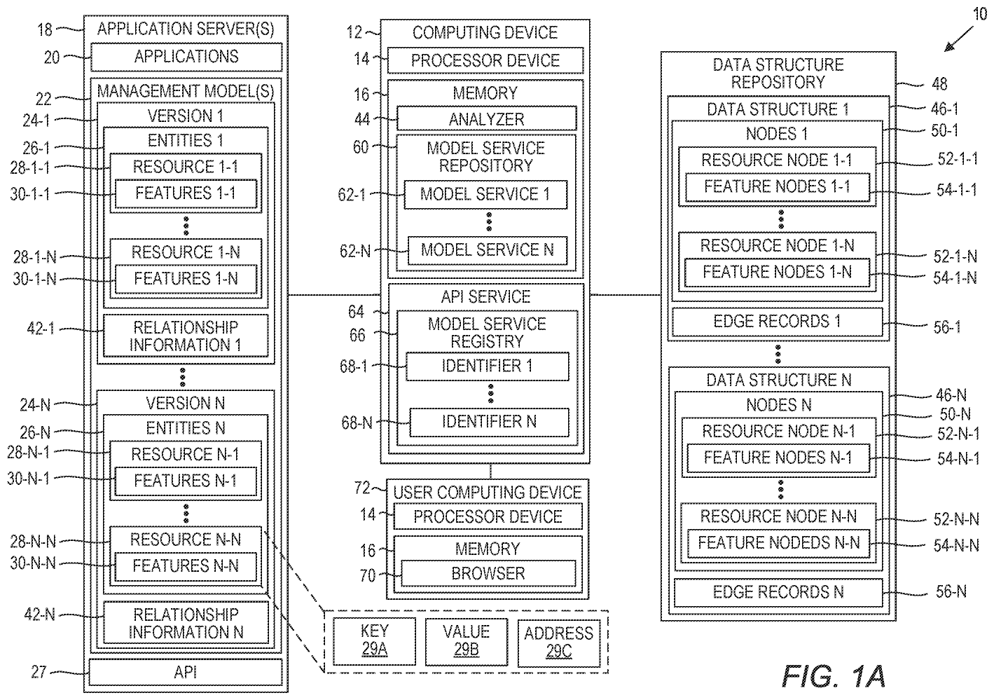

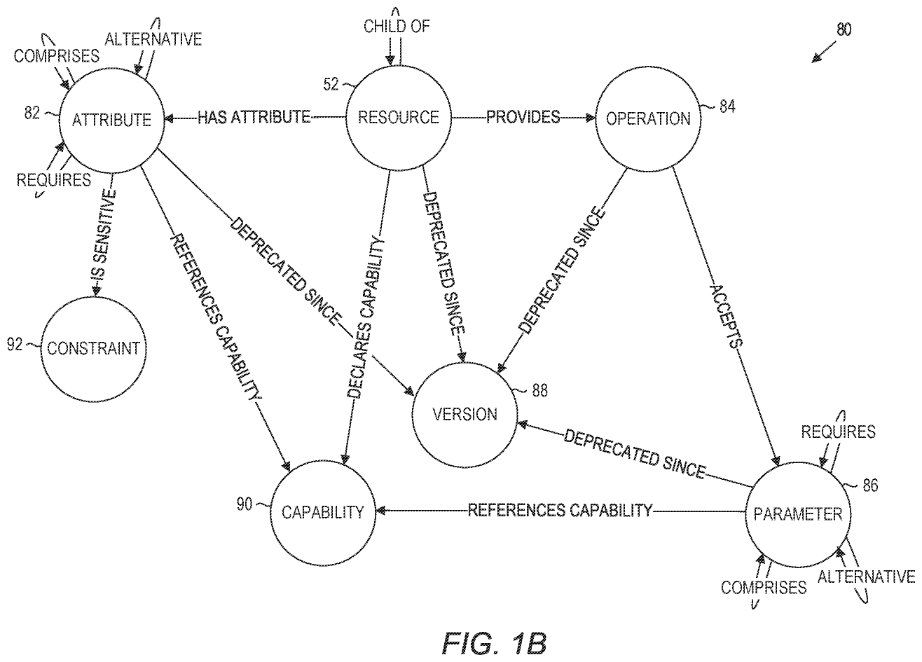

FIG. 1A is a block diagram of a computing system suitable for generating and visualizing a data structure of a management model of an application server according to one example. The computing system 10 includes a computing device 12, which in turn includes a processor device 14 coupled to a memory 16. It is noted that for illustrative purposes to reduce space, only some of the computing devices 12 and other computer components are shown with a processor device 14 and a memory 16. However, each of the computing devices 12 and/or other computer components may include a processor device 14 and/or a memory 16. Further, each of the computing devices 12 may include a plurality of computing devices 12. Collectively, the processor devices 14 may be referred to as a processor device set 14.

The computing device 12 is in communication with one or more application servers 18. The phrase “application server” as used herein refers to a middle ware execution environment that provides services to applications 20 that have been written to interface with the application server, such as, by way of non-limiting example, database connectivity and access services, session security services, state maintenance services, and the like. For example, an application server may host applications 20 and include a database connection service interacts with an application 20 to facilitate connection of the application 20 to a database.

The examples are disclosed herein using a particular application server 18 as an example, in particular the WildFly application server. The WildFly application server is written in Java, implements the Java Platform, Enterprise Edition (Java EE) specification, and runs on multiple platforms. The applications 20 may include any useful or desired application, such as, by way of non-limiting example, a human resources application, a customer relations application, a billing application, and the like.

The application server 18 includes a management model 22, which may have different versions 24-1, 24-N. A management model is a comprehensive service layer model that includes a set of entities 26-1, 26-N accessible through an Application Programming Interface (API) 27. At least a portion of the management model 22 is defined by the application server 18. Accordingly, a management model 22 is generally accessed only when executed by the application server 18. The management model 22 is not generally accessible separate from the application server 18. The management model 22 includes resources 28-1-1-28-N-N (referred to generally as resources 28), and features 30-1-1-30-N-N (referred to generally as features 30), such as attributes, operations, parameters, capabilities, constraints, etc. In certain implementations, the management model includes XML files and metadata regarding resources 28 and/or features 30.

Resources 28 program objects with a unique address, provide operations, may contain attributes, and can declare one or more capabilities. As used herein, reference to a resource is a reference to a resource record of a resource. Each resource includes a key 29A, a value 29B, and an address 29C.

For example, one resource 28 contains a configuration to connect to a database, which is used by the application server 18 to provide a database connection service for the applications 20 running on the application server 18. Resources 28 are organized in a resource tree, where the address for a particular node is the path to the node in the tree. Each segment in a resource 28 address is a key/value pair, where the key is the resource type and the value is the name of a particular resource of the given resource type. For example, resource types include subsystem, interface, socket-binding, etc. Further, the subsystem has child resources of type connector and virtual-server. As another example, names may include web or messaging for a subsystem type resource, or http or https for a web subsystem connectors type resource. Accordingly, the address for a resource 28 is the ordered list of key/value pairs from a root resource of the resource tree to the resource. For example, for resource “connector=http,” the key is “connector,” the value is “http,” and the address is “/subsystem=web/connector=http,” meaning the path to the resource 28 is from the root resource to the resource “subsystem=web.” It is noted that for an HTTP API, a “/” may be used to separate the key and the value instead of an “=”. For example, one such resource address would be “http://localhost:9990/management/subsystem/web/connector/http.” Further, resources 28 may be singletons allowing a fixed number of children or non-singletons allowing an arbitrary number of children.

One example of a resource is “/subsystem=messaging-activemq/server=my-server/jms-queue=my-jms-queue,” which provides a message queue to application developers. Another example of a resource is “/subsystem=batch-jberet/jdbc-job-repository=my-repository,” which provides a job repository for batch processing to application developers.

One feature 30 of a resource 28 is attributes that provide information about the properties or state of the resource 28. In certain implementations, each resource 28 includes at least one attribute. Attributes may have a string name and a value type, such as Boolean, numeric, string, etc. Attributes may be read-only or read-write. Attributes may have two storage types, configuration and runtime. A configuration storage type means the value of the attribute is stored in the persistent configuration, such as in an XML file. A runtime storage type means the value is only available from a running server, and not stored in a persistent configuration.

One feature 30 of a resource 28 is operations that may be implemented by a resource 28, such as to query or modify a state of the resource 28. In certain implementations, an operation has a string name and may include parameters (optional), which is another feature 30 of the resource 28. Each parameter may include a string name and a value type. Parameters may operate similarly to attributes and be used to invoke operations. Some operations are global operations that apply to all resources 28. Some operations only apply to certain resources 28. For example, in certain implementations, every resource 28 except the root resource has an add operation and a remove operation. The add operation may include parameters and the remove operation does not include parameters.

Another feature 30 of a resource 28 is child/parent relationships. Resources 28 may support child resources that are associated with the resource 28. Resources 28 may include descriptions that include metadata describing attributes, operations, and/or child types, or the like.

Another feature 30 of a resource 28 includes capabilities, which have a string name and are declared by resources 28. Capabilities are used to create references between resources 28 and attributes. A value of an attribute can be a capability-reference to indicate that the attribute is a reference to another area of the management model 22.

As noted above, the application server 18 may include different versions 24-1-24-N (may be referred to generally as version 24) of the management model 22 as each new version of the application server 18 includes a new version 24 of the application server 18. The version 24 of the management model 22 is stored in the root resource of the management model 22. Every new version 24 of the management model 22 introduces new resources, attributes, operations and parameters. At the same time other resources, attributes, operations and parameters are marked as deprecated. Every deprecation contains the version 24 from when the element is obsolete and a reason for the deprecation.

The computing device 12 includes an analyzer 44. Because the analyzer 44 is a component of the computing device 12, functionality implemented by the analyzer 44 may be attributed to the computing device 12 generally. Moreover, in examples where the analyzer 44 comprises software instructions that program the processor device 14 to carry out functionality discussed herein, functionality implemented by the analyzer 44 may be attributed herein to the processor device 14.

In certain implementations, the analyzer 44 is a command line tool that parses the management model 22 and stores the information in a data structure 46-1-46-N (may be referred to as a data structure 46), such as a graph database. The data structures 46 may be stored in a data structure repository 48. The analyzer 44 can process the entire management model 22 or a subsection thereof, such as a subtree of the management model 22. It is noted that the analyzer 44 obtains the management model 22 from an executing application server 18 configured to provide one or more services to a plurality of applications 20. Each application 20 is configured to interface with the application server 18 to obtain the one or more services.

The analyzer 44 traverses the resource tree in a recursive manner until all entities 26, such as resources 28 and features 30, are processed and stored in the data structure 46. The analyzer 44 creates a new data structure 46 for each version 24 of the management model 22. Further, the entities 26 of the management model 22 are saved as nodes 50 in the data structure 46. For example, the entities 26-1 of a first version 24-1 of the management model 22 are stored as nodes 50-1 of a first data structure 46-1. Resources 28 of the management model 22 are stored as resource nodes 52-1-1-52-N-N (referred to generally as resource nodes 52), and features 30 of the management model 22 are stored as feature nodes 54-1-1-54-N-N (referred to generally as feature nodes 54). Each of the resource nodes 52 corresponds to a different one of the resources 28 of the management model 22. It is noted that any reference to resource nodes 52 and/or feature nodes 54 is a reference to resource node records and/or feature node records.

For example, for each resource 28, the analyzer 44 executes the read-resource-description operation for the resource 28. The analyzer 44 stores the resource 28, including the key, value, address, and/or description, as a resource node 52 in the data structure 46. The analyzer 44 also stores any features 30 as a feature node 54 in the data structure. For example, attributes, operations, parameters, capabilities, constraints, and versions are stored in the data structure 46. Further, the analyzer 44 stores relationship information 42-1-42-N (may be referred to generally as relationship information 42) of the management model 22 associated with the resource node 52 in the data structure 46 as edge records 56-1-56-N (may be referred to generally as edge records 56). At least a portion of the edge records 56 identify a relationship between resource nodes 52, such as between a resource 28 and a parent resource or child resource. At least a portion of the edge records 56 identify a relationship between a resource node 52 and a feature node 54. For example, linking a particular resource with a particular operation, linking a particular resource with a particular attribute, or the like.

As noted above, in certain implementations, the data structure 46 is a graph database structure. As noted above, use of the data structure 46 allows for queries directed to the management model 22 without need for a running application server 18. Especially as querying different versions of the management model 22 or comparing resources 28 between different versions would require many different application servers 18. Further, some information may be hidden in the management model 22 and/or hard to find. Use of an independent data structure 46 provides easier and faster access.

To use the data structures 46, the computing device 12 includes a model service repository 60 including a plurality of model services 62-1-62-N (referred to generally as model service 62). Each model service 62 may use a REST (representational state transfer) API to retrieve specification information about the management model 22 from the data structures 46. Each model service 62 is bound to one data structure 46, which itself represents one specific version 24 of the management model 22. In certain implementations, the model service 62 defines endpoints, such as URLs, which may return JSON (JavaScript Object Notation). The computing device 12 further includes an API service 64 with a model service registry 66. Each model service 62 registers with the model service registry 66 using a unique identifier 68-1-68-N (may be referred to generally as identifier 68). The unique identifier may contain information specific to the version 24 of the management model 22, such as: Upon startup the model service registers itself at the API service using a unique identifier. The identifier contains central information from the analyzed management model: <product name>-<product version>-mgt-<management version>.

A user, through a browser 70 on a user computing device 72, sends a request to the API service 64. The API service 64 provides a registry for the model services 62, a single point of contact and proxy for the browser 70, and computes differences between different versions of resources 28, such as through two versions 24 of the management model 22. In certain implementations, the API service 64 extracts the identifier 68 from the URL in the request to identify the particular model service 62 being queried.

The API service 64 can compare a resource 28 between two different versions 24 of a management model 22. In certain implementations, the API service 64 produces a JSON patch document that contains operations describing the necessary modifications to turn the source version into the target version. The API service 64 uses the model service 62 to get the resource descriptions, and then generates a JSON patch and uses the mime type application/json-patch+json to send the result back to the client.

Some example queries that may be made by the user computing device 72 are as follows:

/management-model/query?name=<name>: Returns all resources, attributes, operations, and capabilities which match the given name.

/management-model/deprecations?since=<version>: Returns all resources, attributes, operations and parameters which have been marked as deprecated since the given version.

/resources/query?name=<name>: Returns all resources which match the given name.

/resources/deprecations?since=<version>: Returns all deprecated resources since the given version.

/resources/resource?address=<address>&skip=a|o|g|c: Returns the resource with the given address with all attributes, operations, and capabilities, but without child resources.

/resources/subtree?address=<address>: Returns a sub-tree starting at the root resource down to the resource with the given address.

/resources/children?address=<address>: Returns the direct children of the resource with the given address.

/attributes/query?name=<address>: Returns all attributes which match (ignore case) the given name.

/attributes/deprecations?since=<version>: Returns all deprecated attributes since the given version. If the version is omitted, this endpoint returns all deprecations.

/operations/query?name=<name>: Returns all operations which match (ignore case) the given name.

/operations/deprecations?since=<version>: Returns all deprecated operations since the given version. If the version is omitted, this endpoint returns all deprecations.

/capabilities/query?name=<name>: Returns all capabilities which match (ignore case) the given name.

Accordingly, data of the management model 22 of the application server 18 is prepared and stored in such a way to facilitate performance of certain tasks. For example, the data structure 46 may provide a graphical representation of resources 28. The data structure 46 may illustrate relationships between resources 28, and capabilities, operations, and attributes of the resources 28. The data structure 46 facilitates finding inconsistencies and identifying weakness and opportunities for optimizations. The data structure may facilitate performing evaluations and analyses over a multitude of resources 28, attributes, and operations. The data structure 46 may facilitate finding attributes which have been marked as deprecated since a given version.

FIG. 1B is a diagram of a data structure 46 embodied as a graph database 80 of the computing system of FIG. 1A according to one example. The graph database 80 includes a plurality of nodes, each of which may include a further plurality of nodes 52, 54. The graph database 80 includes resource nodes 52 and feature nodes 54 (see FIG. 1A). The feature nodes 54 include attribute nodes 82, operation nodes 84, parameter nodes 86, version nodes 88, capability nodes 90, and constraint nodes 92. Further, the graph database 80 includes relationships between the resource nodes 52 and feature nodes 54.

For example, a resource node 52 may be linked to one or more other resource nodes 52 indicating a relationship that the resource node 52 is a child of the other resource nodes 52. The resource node 52 may be linked to one or more operation nodes 84 indicating a relationship that the resource node 52 provides the one or more operations. The resource node 52 may be linked to one or more capability nodes 90 indicating that the resource node 52 declares the one or more capabilities. The resource node 52 may be linked to one or more attribute nodes 82 indicating a relationship that the resource node 52 has the one or more attributes.

For each attribute, the analyzer 44 stores the attribute and basic properties thereof, such as data type, access type, and/or storage type, in an attribute node 82 (may also be referred to as an attribute node record). If the attribute references a capability, the analyzer 44 stores the relationship to the capability. If the attribute has constraints, requires other attributes, or defines alternatives, the analyzer 44 stores information such as relationships in the data structure 46. An attribute node 82 holds most of metadata of the attribute, such as type, required, nillable, storage, etc. Type may include string or a complex data type of other attributes. An attribute node 82 may be linked to one or more other attribute nodes 82 indicating a relationship that the attribute node 82 is an alternative of the other attribute nodes 82, comprises the other attribute nodes 82 (e.g., as in a complex attribute), and/or requires the other attribute nodes 82, or the like. Further, the attribute node 82 may be linked to a capability node 90 indicating a relationship that the attribute node 82 references a capability. The attribute node 82 may be linked to one or more constraint nodes 92 indicating a relationship that the attribute is sensitive to the constraint.

For each operation, the analyzer 44 stores the operation and basic properties thereof, such as data type, access type, and/or storage type, in an operation node 84 (may also be referred to as an operation node record). Each operation node record 84 corresponds to an operation implementable by a resource 28. For each parameter of the operation, the analyzer 44 stores the parameter and basic properties thereof, such as data type, access type, and/or storage type, in a parameter node 86 (may also be referred to as a parameter node record). If the parameter references a capability, the analyzer 44 stores a relationship to this capability in the data structure 46. If the parameter has constraints, requires other attributes, or defines alternatives, the analyzer 44 stores such information as relationships in the data structure 46. In certain implementations, global operations are stored only once in the database.

An operation node 84 may be linked to one or more parameter nodes 86 indicating a relationship that the operation node 84 accepts the parameter node 86. The parameter node 86 may be linked to one or more other parameter nodes 86 indicating a relationship that the parameter node 86 requires the other parameter nodes 86, comprises the other parameter nodes 86, and/or is an alternative to the other parameter nodes 86, or the like. Further, the parameter node 86 may be linked to one or more capability nodes 90 indicating a relationship that the parameter node 86 references the capability node 90.

Version information may be stored in version nodes 88 (may also be referred to as a version node records). A set of the version nodes 88 corresponds to resources 28. One or more of the resource nodes 52, attribute nodes 82, operation nodes 84, and/or parameter nodes 86 may be linked to a version node 88 indicating a relationship that the nodes are associated with and/or deprecated since a particular version.

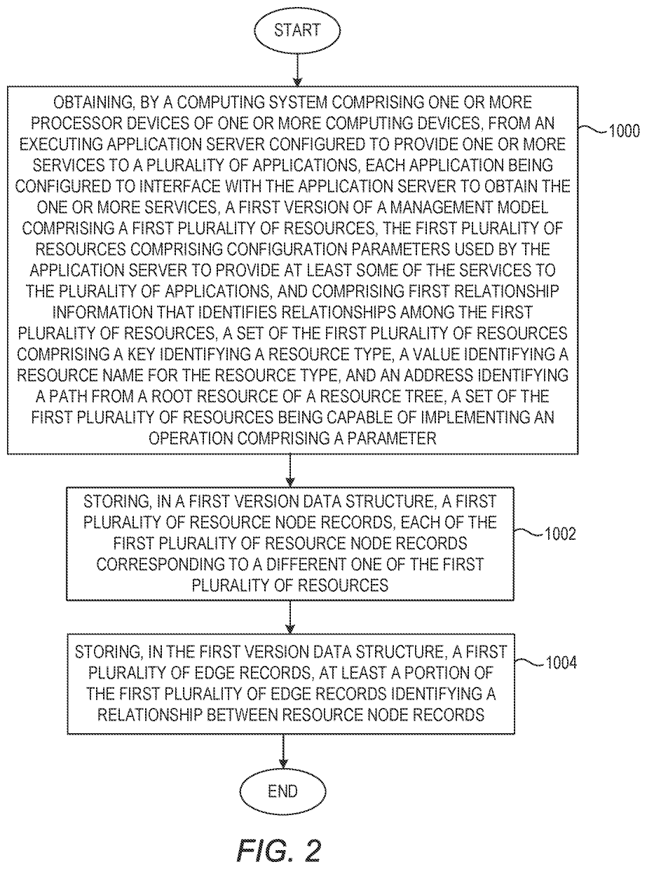

FIG. 2 is a flowchart of a method for generating a data structure 46 of a management model 22 of an application server 18 according to one example. FIG. 2 will be discussed in conjunction with FIGS. 1A-1B. A computing system 10 including one or more processor devices 14 of one or more computing devices 12 obtains, from an executing application server 18 configured to provide one or more services to a plurality of applications 20, each application 20 being configured to interface with the application server 18 to obtain the one or more services, a first version 24-1 of a management model 22 comprising a first plurality of resources 28 (1000). The first plurality of resources 28 includes configuration parameters used by the application server to provide at least some of the services to the plurality of applications 20, and includes first relationship information 42 that identifies relationships among the first plurality of resources 28. A set of the first plurality of resources 28 includes a key 29A identifying a resource type, a value 29B identifying a resource name for the resource type, and an address 29C identifying a path from a root resource of a resource tree. A set of the first plurality of resources 28 is capable of implementing an operation comprising a parameter.

The computing system 10 stores, in a first version data structure 46, a first plurality of resource node records 52, each of the first plurality of resource node records 52 corresponding to a different one of the first plurality of resources 28 (1002). The computing system 10 stores, in the first version data structure 46, a first plurality of edge records 56, at least a portion of the first plurality of edge records 56 identifying a relationship between resource node records 52 (1004).

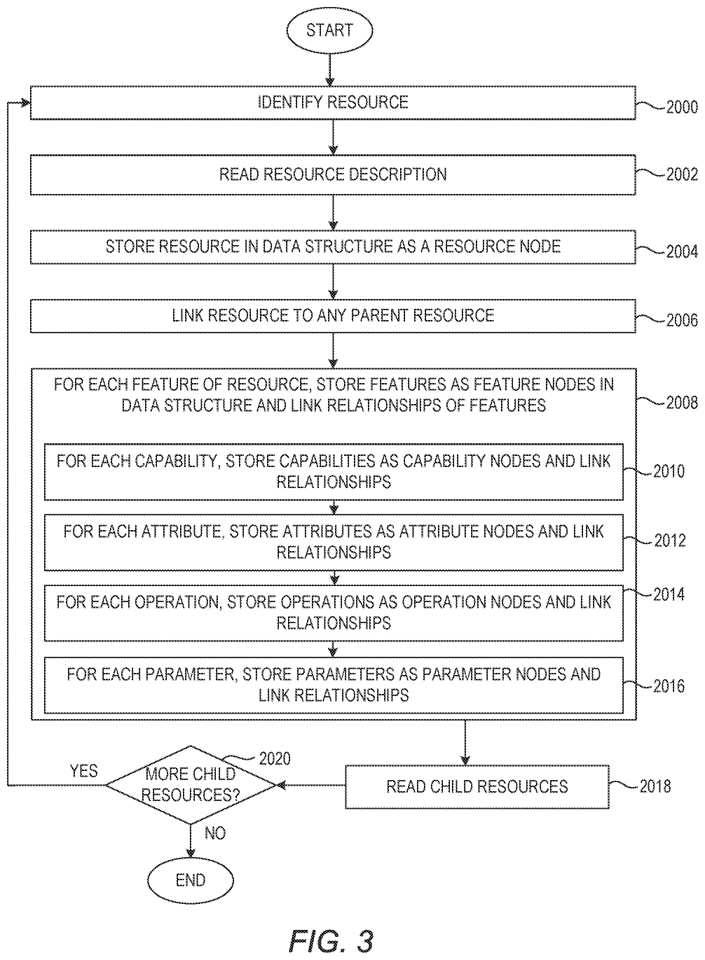

FIG. 3 is a flowchart illustrating a method for generating a data structure 46 of a management model 22 of an application server 18 according to one example. The analyzer 44 identifies a resource 28 (2000) and reads a resource description of the resource 28 (2002). The analyzer 44 stores the resource 28 in a data structure 46, such as a graph database, as a resource node 52 (2004). The analyzer 44 links the resource 28 to any parent resource (2006). It is noted that the root resource does not have a parent resource. The analyzer 44, for each feature of the resource 28, stores features as feature nodes 54 in the data structure 46 and links relationships of features, such as to resource nodes 52 and other feature nodes 54 (2008). In particular, for each capability, the analyzer 44 stores capabilities as capability nodes 90 and links relationships (2010). For each attribute, the analyzer 44 stores attributes as attribute nodes 82 and links relationships (2012). For each operation, the analyzer 44 stores operations as operation nodes 84 and links relationships (2014). For each parameter, the analyzer 44 stores parameters as parameter nodes 86 and links relationships (2016).

The analyzer 44 reads child resources, if any (2018). The analyzer 44 then determines whether there are more child resources (2020). If so, the process proceeds to step 2000 and the child resource is identified. If not, the process ends. In this way, the process continues until the analyzer reads each resource 28.

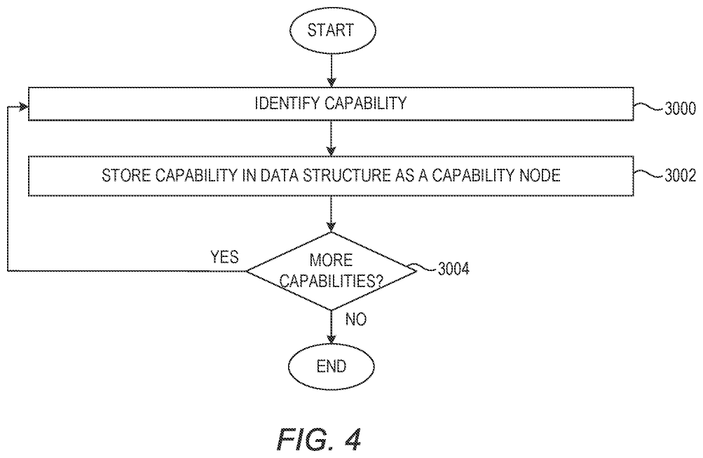

FIG. 4 is a flowchart illustrating a method for generating capability nodes 90 in the data structure 46 according to one example. The analyzer 44 identifies a capability (3000) and then stores the capability in the data structure as a capability node 90 (3002). The analyzer 44 determines whether there are more capabilities (3004). If so, the process proceeds to step 3000. Otherwise, the process ends. In particular, for each resource 28, the analyzer 44 identifies and stores the related capabilities. In this way, the process continues until the analyzer has read each capability of a resource 28.

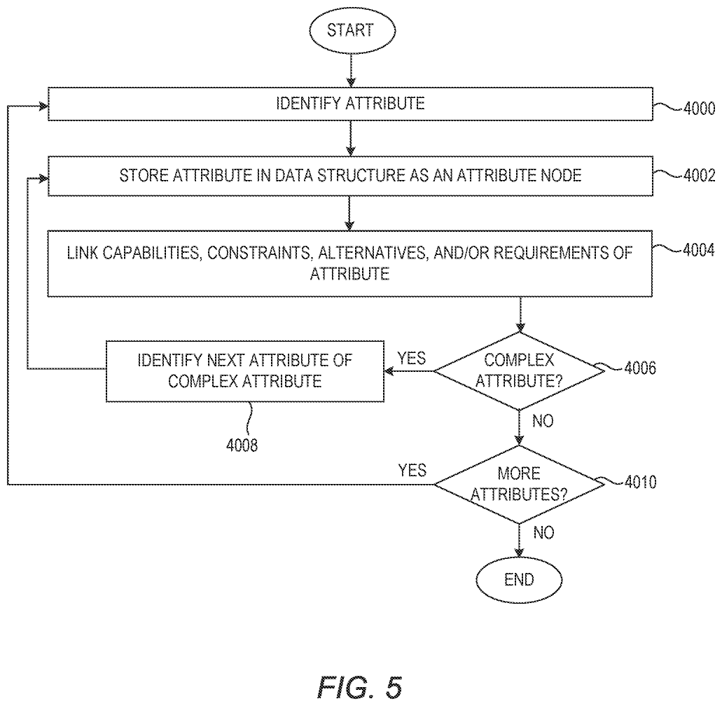

FIG. 5 is a flowchart illustrating a method for generating attribute nodes 82 in the data structure 46 according to one example. The analyzer 44 identifies an attribute (4000) and stores the attribute in the data structure 46 as an attribute node 82 (4002). The analyzer 44 links capabilities, constraints, alternatives, and/or requirements of the attribute (4004). The analyzer 44 determines whether the attribute is a complex attribute (4006). If so, the analyzer 44 identifies a next attribute of the complex attribute (4008), and then proceeds to step 4002. In this way, the process continues until each attribute of the complex attribute is stored in the data structure 46 as an attribute node 82. If in step 4006, the attribute is not complex attribute, the analyzer 44 determines whether there are more attributes (4010). If so, the process proceeds to step 4000. Otherwise, the process ends. In this way, the process continues until the analyzer 44 has stored each attribute of a resource as an attribute node 82.

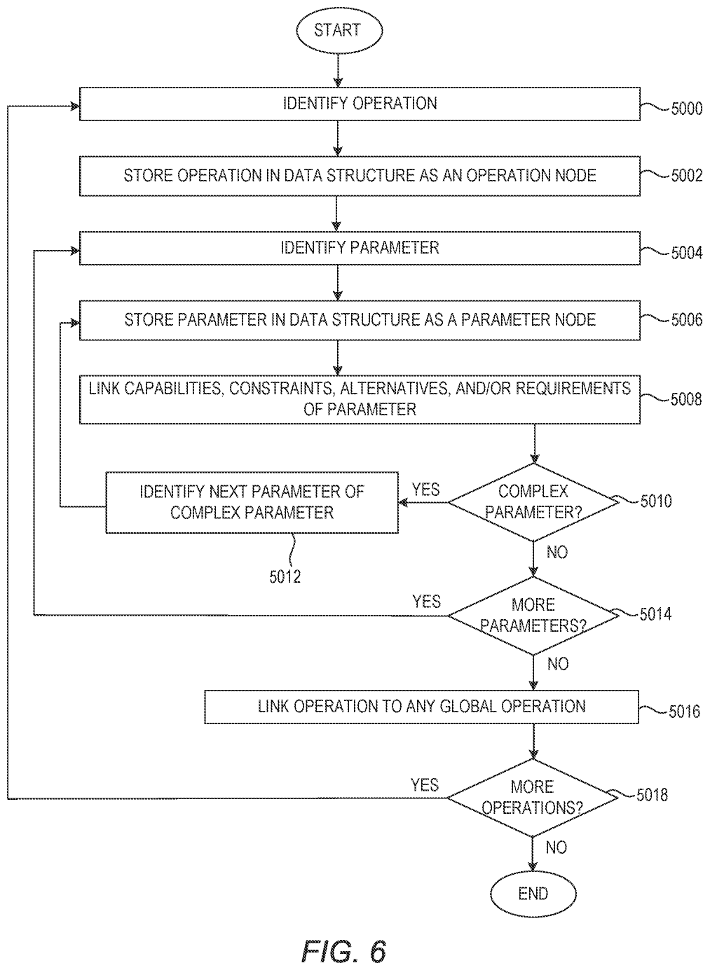

FIG. 6 is a flowchart illustrating a method for generating operation nodes 84 and parameter nodes 86 of the data structure 46 according to one example. The analyzer 44 identifies an operation (5000) and stores the operation in the data structure 46 as an operation node 84 (5002). The analyzer 44 then identifies a parameter of the operation (5004) and stores the parameter in the data structure 46 as a parameter node 86 (5006). The analyzer 44 links capabilities, constraints, alternatives, and/or requirements of the parameter (5008). The analyzer 44 determines whether the parameter is a complex parameter (5010). If so, the analyzer 44 identifies the next parameter of the complex parameter (5012), and proceeds to step 5004. In this way, the process continues until each parameter of the complex parameter is stored in the data structure 46 as a parameter node 86. If in step 5010, the parameter is not a complex parameter, the analyzer 44 determines whether there are more parameters (5014). If so, the process proceeds to step 5004. If not, the analyzer 44 links the operation to any global operation (5016), if applicable. The analyzer 44 then determines whether there are more operations (5018). If so, the process proceeds to step 5000. If not, the process ends. In this way, the process continues until the analyzer 44 has stored each operation as an operation node 84, and each corresponding parameter as a parameter node 86.

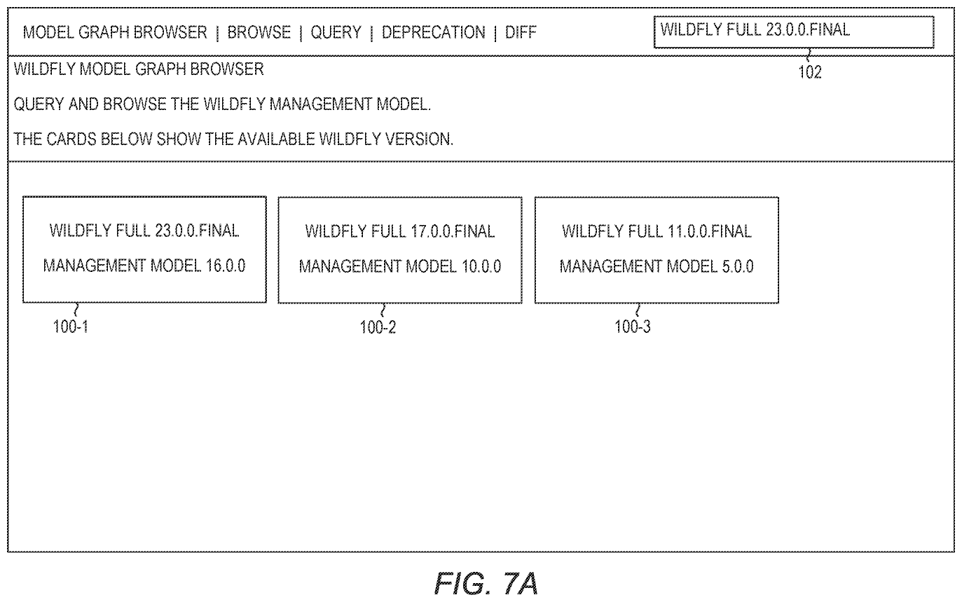

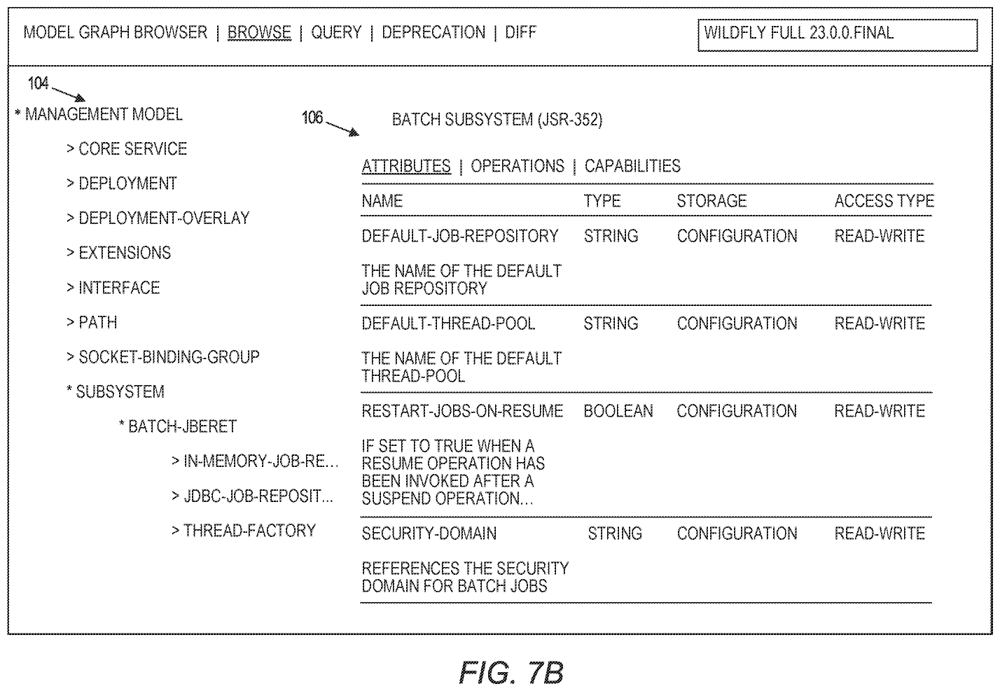

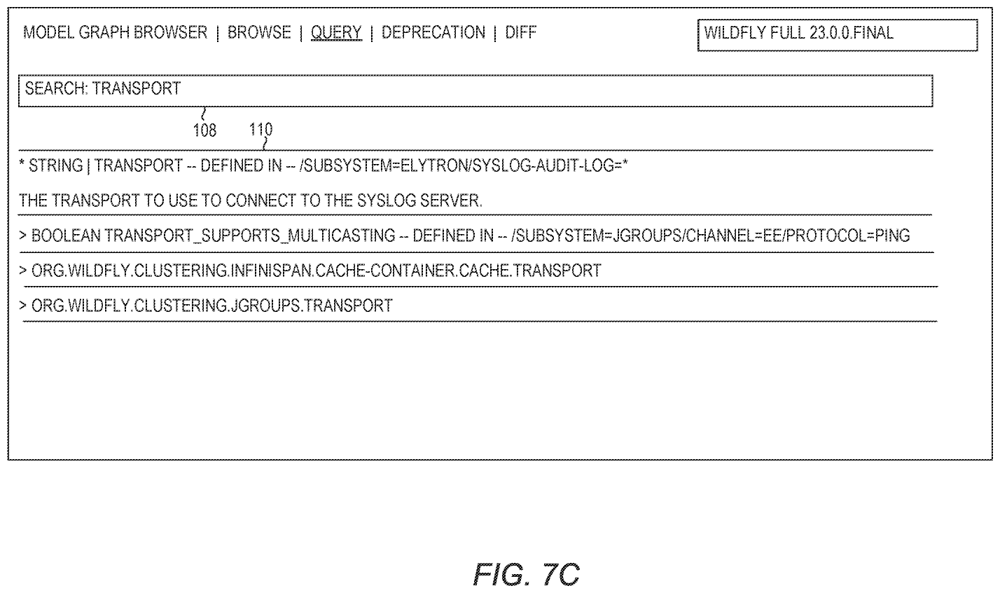

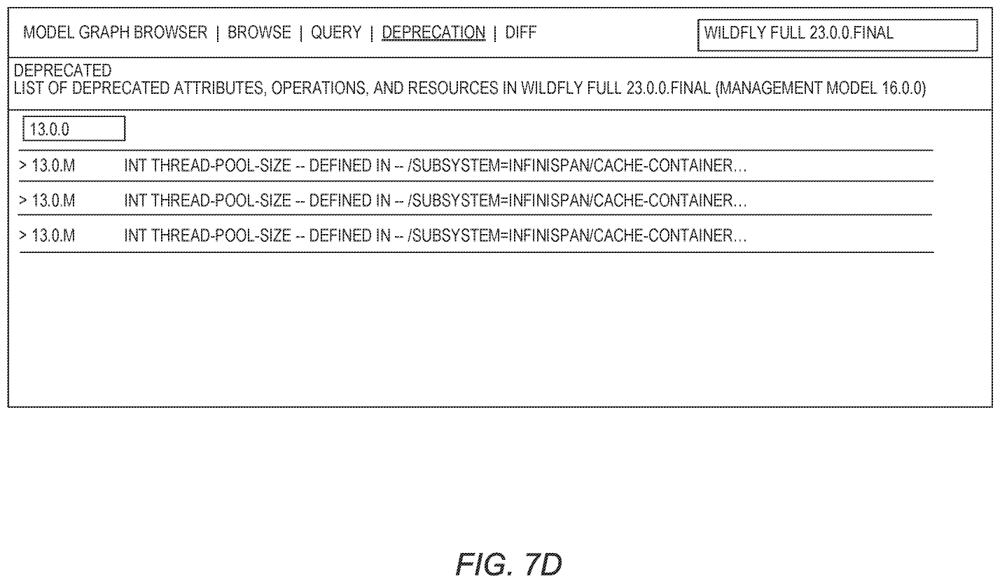

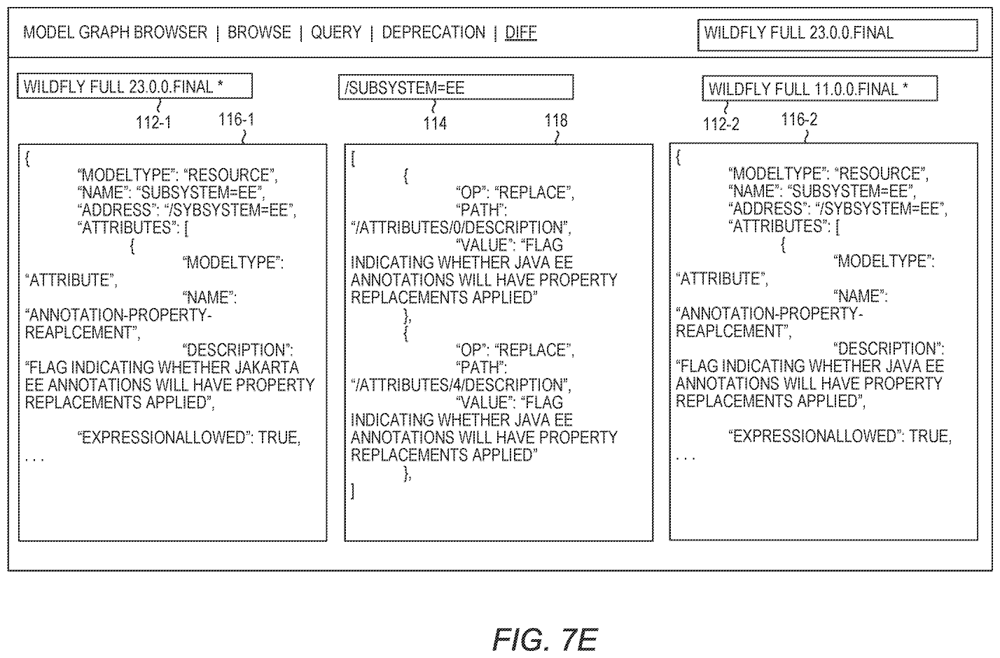

FIGS. 7A-7E are diagrams illustrating a graphical user interface of the system of FIGS. 1A-1B. In particular, FIG. 7A illustrates a graphical user interface (GUI) providing different WildFly versions and associated management model versions. In this example, the browser provides a first card 100-1 of WildFly version 23.0.0 and corresponding management model version 16.0.0, a second card 100-2 of WildFly version 17.0.0 and corresponding management model 10.0.0, and a third card 100-3 of WildFly version 11.0.0 and corresponding management model 5.0.0. The user can switch the active WildFly version using the cards 100-1-100-3 on the home screen or using the context selector 102 in the header.

FIG. 7B illustrates a GUI providing a navigation of resources and corresponding features. For example, the GUI provides an expandable list 104 of the resource tree of resources 28 associated with a management model 22. Selecting a resource 28 provides details of the selected resource 28, such as attributes, operations and capabilities. The list of resources 28 includes Core Service, Deployment, Deployment-Overlay, Extensions, Interface, Path, Socket-Binding-Group, and Subsystem. Further, the Subsystem resource has a child resource of Batch-Jberet, which has further child resources.

The GUI provides a feature section 106 providing attributes, operations, and capabilities. For example, for the Batch-Jberet resource, the table current provides associated attributes and corresponding information, including name, description, type, storage, and access type. Attributes of the batch subsystem include a default-job-repository, default-thread-pool, restart-jobs-on-resume, and security-domain. Attributes of restart-jobs-on-resume states that if set to true when a resume operation is to be invoked after a suspend operation, any jobs stopped during the suspend will be restarted, and a value of false will leave the job in a stopped state. Attributes of security-domain references the security domain for batch jobs, and this can only be defined if the Elytron subsystem is available.

FIG. 7C illustrates a GUI providing text search functionality. For example, the GUI provides a text search bar 108, and a user has requested a search for the word “transport.” The GUI provides a search results list 110 providing those nodes containing the term “transport,” such as in the name or description of the node. The search result list 110 can be filtered by resources, attributes, operations, and capabilities.

FIG. 7D illustrates a GUI providing deprecated attributes, operations, and/or resources associated with a particular version, such as with WildFly 23.0.0 and management model version 16.0.0. For example, the deprecated attributes include thread-pool-size. This screen shows a list of all deprecated resources, attributes, and operations. It can be filtered by version and element type. With this information at hand, an administrator can quickly get a grasp about what has changed compared to the last version.

FIG. 7E illustrates a GUI providing differences between resources. In particular, the GUI provides a first version selector 112-1, a second version selector 112-2, and a resource selector 114. For example, the first version is WildFly Full 23.0.0Final, the second version is WildFly Full 11.0.0.Final, and the resource is /subsystem=ee. A first version of /subsystem=ee associated with WildFly Full 23.0.0.Final is provided in a first resource version section 116-1, and a second version of /subsystem=ee associated with WildFly Full 11.0.0.Final is provided in a second resource version section 116-2. A comparison version section 118 is provided therebetween, illustrating differences between the first resource version and the second resource version. In certain implementations, the difference is shown as a JSON patch.

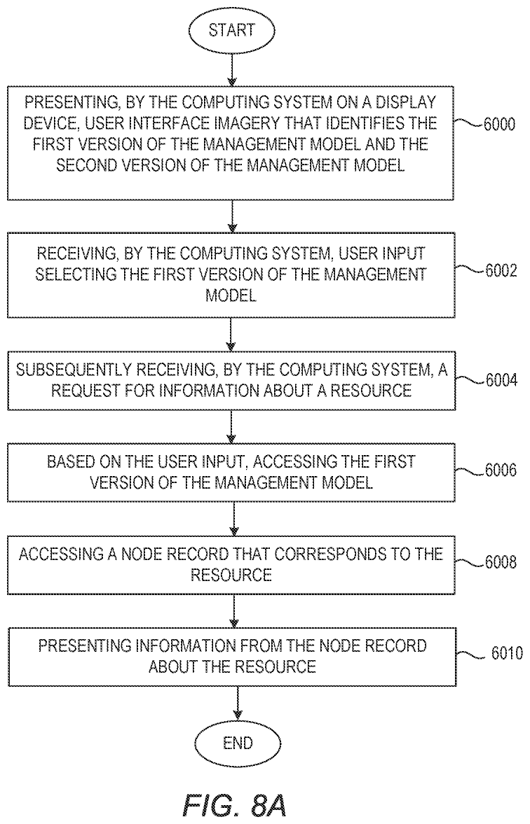

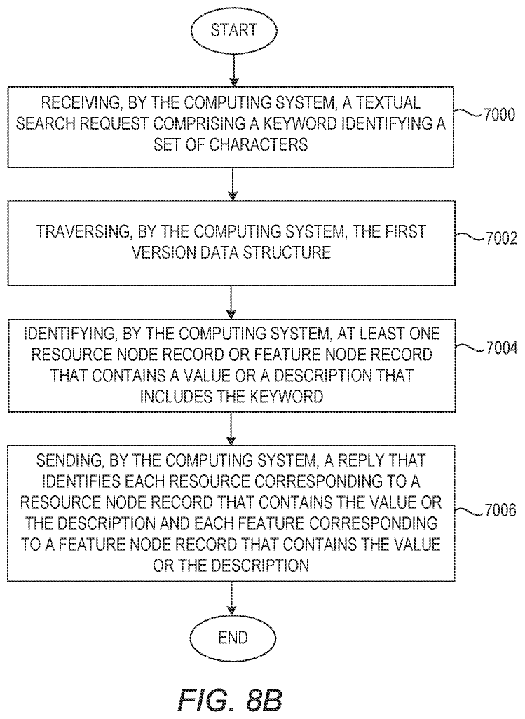

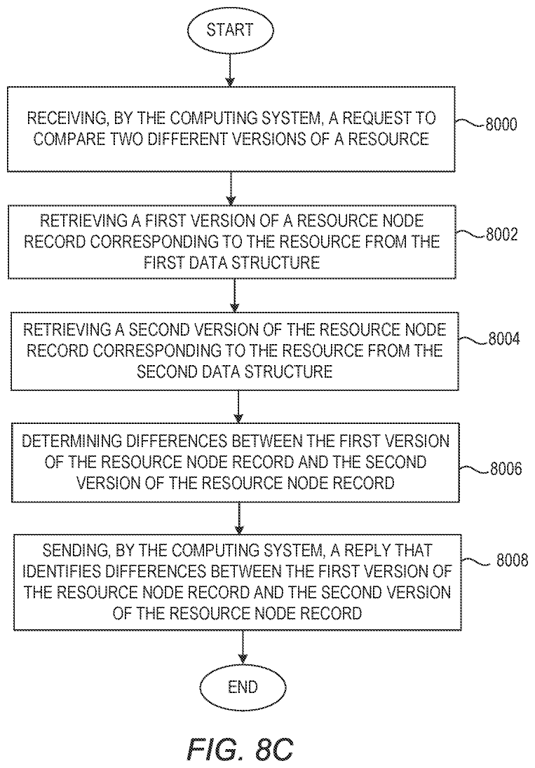

FIG. 8A is a flowchart illustrating accessing different versions of a management model according to one implementation. The computing system 10 on a display device presents user interface imagery that identifies the first version 24 of the management model 22 and the second version 24 of the management model 22 (6000). The computing system 10 receives user input selecting the first version 22 of the management model 24 (6002). The computing system 10 subsequently receives a request for information about a resource 28 (6004). The computing system 10, based on the user input, accesses the first version 24 of the management model 22 (6006). The computing system 10 accesses a node record 52 that corresponds to the resource 28 (6008). The computing system 10 presents information from the node record 52 about the resource 28 (6010).

FIG. 8B is a flowchart illustrating conducting a textual search request of a management model according to one implementation. The computing system 10 receives a textual search request comprising a keyword identifying a set of characters (7000). The computing system 10 traverses the first version data structure 46 (7002). The computing system 10 identifies at least one resource node record 52 or feature node record 54 that contains a value or a description that includes the keyword (7004). The computing system 10 sends a reply that identifies each resource 28 corresponding to a resource node record 52 that contains the value or the description and each feature 30 corresponding to a feature node record 54 that contains the value or the description (7006).

FIG. 8C is a flowchart illustrating comparing two different versions of a resource of a management model according to one implementation. The computing system 10 receives a request to compare two different versions of a resource 28 (8000). The computing system 10 retrieves a first version 24 of a resource node record 52 corresponding to the resource 28 from the first data structure 46 (8002). The computing system 10 retrieves a second version 24 of the resource node record 52 corresponding to the resource 28 from the second data structure 46 (8004). The computing system 10 determines differences between the first version of the resource node record 52 and the second version of the resource node record 52 (8006). The computing system sends a reply that identifies differences between the first version 24 of the resource node record 52 and the second version 24 of the resource node record 52 (8008).

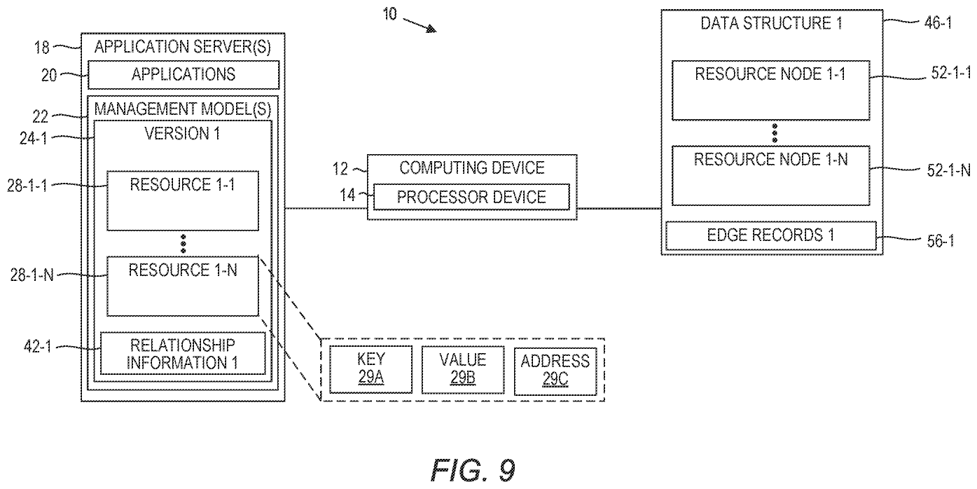

FIG. 9 is a simplified block diagram of the computing system 10 illustrated in FIG. 1A according to one implementation. In this example, the computing system 10 includes one or more processor devices 14 of one or more computing devices 12. The computing system 10 obtains from an executing application server 18 configured to provide one or more services to a plurality of applications 20, each application 20 being configured to interface with the application server 18 to obtain the one or more services, a first version 24-1 of a management model 22 comprising a first plurality of resources 28. The first plurality of resources 28 includes configuration parameters used by the application server 18 to provide at least some of the services to the plurality of applications 20, and includes first relationship information 42-1 that identifies relationships among the first plurality of resources 28. A set of the first plurality of resources 28 includes a key 29A identifying a resource type, a value 29B identifying a resource name for the resource type, and an address 29C identifying a path from a root resource of a resource tree. A set of the first plurality of resources 28 is capable of implementing an operation comprising a parameter. The computing system 10 stores, in a first version data structure 46-1, a first plurality of resource node records 52, each of the first plurality of resource node records 52 corresponding to a different one of the first plurality of resources 28. The computing system stores, in the first version data structure 46-1, a first plurality of edge records 56-1, at least a portion of the first plurality of edge records 56-1 identifying a relationship between resource node records 52.

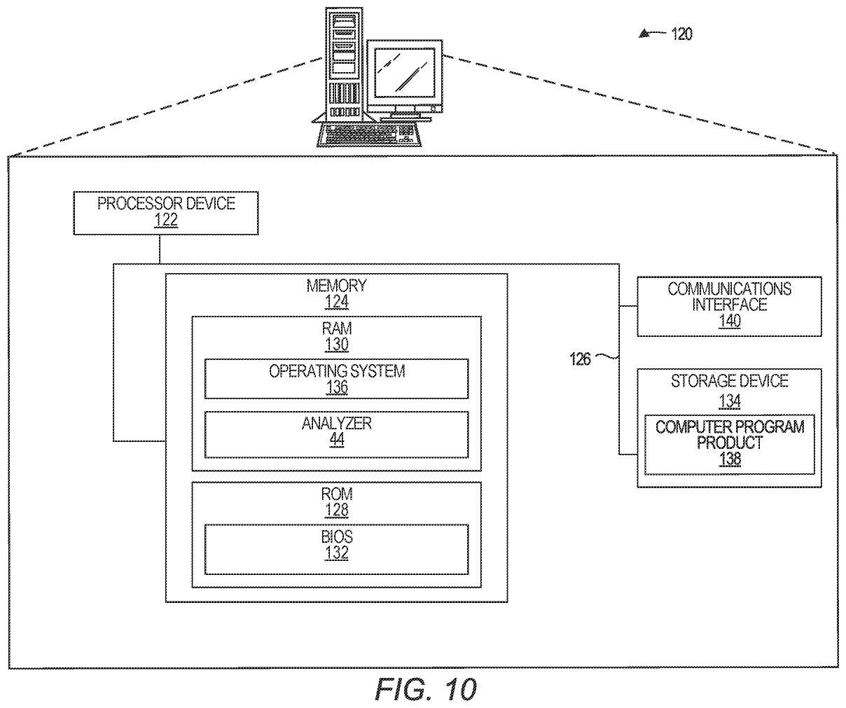

FIG. 10 is a block diagram of a computing device 120 containing components suitable for implementing any of the processing devices disclosed herein. The computing device 120 includes a processor device 122, a system memory 124, and a system bus 126. The system bus 126 provides an interface for system components including, but not limited to, the system memory 124 and the processor device 122. The processor device 122 can be any commercially available or proprietary processor.

The system bus 126 may be any of several types of bus structures that may further interconnect to a memory bus (with or without a memory controller), a peripheral bus, and/or a local bus using any of a variety of commercially available bus architectures. The system memory 124 may include non-volatile memory 128 (e.g., read-only memory (ROM), erasable programmable read-only memory (EPROM), electrically erasable programmable read-only memory (EEPROM), etc.), and volatile memory 130 (e.g., random-access memory (RAM)). A basic input/output system (BIOS) 132 may be stored in the non-volatile memory 128 and can include the basic routines that help transfer information between elements within the computing device 120. The volatile memory 130 may also include a high-speed RAM, such as static RAM, for caching data.

The computing device 120 may further include or be coupled to a non-transitory computer-readable storage medium such as storage device 134, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 134 and other drives associated with computer-readable media and computer-usable media may provide non-volatile storage of data, data structures, computer-executable instructions, and the like.

A number of modules can be stored in the storage device 134 and in the volatile memory 130, including an operating system 136 and one or more program modules, which may implement the functionality described herein in whole or in part. All or a portion of the examples herein may be implemented as a computer program product 138 stored on a transitory or non-transitory computer-usable or computer-readable storage medium, such as the storage device 134, which includes complex programming instructions, such as complex computer-readable program code, to cause the processor device 122 to carry out the steps described herein. Thus, the computer-readable program code can comprise software instructions for implementing the functionality of the examples described herein when executed on the processor device 122. The processor device 122, in conjunction with the network manager in the volatile memory 130, may serve as a controller or control system for the computing device 120 that is to implement the functionality described herein.

The computing device 120 may also include one or more communication interfaces 140, depending on the particular functionality of the computing device 120. The communication interfaces 140 may comprise one or more wired Ethernet transceivers, wireless transceivers, fiber, satellite, and/or coaxial interfaces by way of non-limiting examples.

Individuals will recognize improvements and modifications to the preferred examples of the disclosure. All such improvements and modifications are considered within the scope of the concepts disclosed herein and the claims that follow.

What is claimed is:

1. A method comprising:
obtaining, by a computing system comprising one or more processor devices of one or more computing devices, from an executing application server configured to provide one or more services to a plurality of applications, each application being configured to interface with the application server to obtain the one or more services, a first version of a management model comprising a first plurality of resources, the first plurality of resources comprising configuration parameters used by the application server to provide at least some of the services to the plurality of applications, and comprising first relationship information that identifies relationships among the first plurality of resources, a set of the first plurality of resources comprising a key identifying a resource type, a value identifying a resource name for the resource type, and an address identifying a path from a root resource of a resource tree, a set of the first plurality of resources being capable of implementing an operation comprising a parameter;
storing, in a first version data structure, a first plurality of resource node records, each of the first plurality of resource node records corresponding to a different one of the first plurality of resources; and
storing, in the first version data structure, a first plurality of edge records, at least a portion of the first plurality of edge records identifying a relationship between resource node records.

2. The method of claim 1, wherein the application server comprises a WildFly Application server.

3. The method of claim 1, wherein each resource in the set of the first plurality of resources comprises at least one attribute that comprises information about a state of the resource.

4. The method of claim 1, wherein one of the one or more services comprises a database connection service that connects an application to a database.

5. The method of claim 1, wherein storing, in the first version data structure, the first plurality of resource node records further comprises:
storing, in a first graph database, the first plurality of resource node records.

6. The method of claim 1, further comprising storing, in the first version data structure, a first plurality of feature node records, a set of the first plurality of feature node records corresponding to at least one of the first plurality of resources.

7. The method of claim 6, wherein storing, in the first version data structure, the first plurality of feature node records, a set of the first plurality of feature node records corresponding to at least one of the first plurality of resources further comprises:
storing, in the first version data structure, a first plurality of attribute node records, a set of the first plurality of attribute node records corresponding to at least one of the first plurality of resources, each attribute node record corresponding to an attribute of a resource.

8. The method of claim 6, wherein storing, in the first version data structure, the first plurality of feature node records, a set of the first plurality of feature node records corresponding to at least one of the first plurality of resources further comprises:
storing, in the first version data structure, a first plurality of attribute node records, at least one of the first plurality of attribute node records corresponding to a complex attribute defined by a plurality of attributes.

9. The method of claim 6, wherein storing, in the first version data structure, the first plurality of feature node records, a set of the first plurality of feature node records corresponding to at least one of the first plurality of resources further comprises:
storing, in the first version data structure, a first plurality of operation node records, a set of the first plurality of operation node records corresponding to at least one of the first plurality of resources, each operation node record corresponding to an operation implementable by a resource.

10. The method of claim 6, wherein storing, in the first version data structure, the first plurality of feature node records, a set of the first plurality of feature node records corresponding to at least one of the first plurality of resources further comprises:
storing, in the first version data structure, a first plurality of version node records, a set of the first plurality of version node records corresponding to at least one of the first plurality of resources.

11. The method of claim 1, wherein storing, in the first version data structure, the first plurality of edge records, at least a portion of the first plurality of edge records identifying the relationship between resource node records further comprises:
storing, in the first version data structure, the first plurality of edge records, at least a portion of the first plurality of edge records identifying a relationship between a resource node record and at least one of a parent resource node record or a child resource node record.

12. The method of claim 1,
further comprising storing, in the first version data structure, a first plurality of feature node records, a set of the first plurality of feature node records corresponding to at least one of the first plurality of resources;
wherein storing, in the first version data structure, the first plurality of edge records further comprises:
storing, in the first version data structure, the first plurality of edge records, at least a portion of the first plurality of edge records identifying a relationship between a resource node record and a feature node record.

13. The method of claim 1,
further comprising storing, in the first version data structure, a first plurality of feature node records, a set of the first plurality of feature node records corresponding to at least one of the first plurality of resources;
wherein storing, in the first version data structure, the first plurality of edge records further comprises:
storing, in the first version data structure, the first plurality of edge records, at least a portion of the first plurality of edge records identifying a relationship between feature node records.

14. The method of claim 1, further comprising:
receiving, by the computing system, a textual search request comprising a keyword identifying a set of characters;
traversing, by the computing system, the first version data structure;
identifying, by the computing system, at least one resource node record or feature node record that contains a value or a description that includes the keyword; and
sending, by the computing system, a reply that identifies each resource corresponding to a resource node record that contains the value or the description and each feature corresponding to a feature node record that contains the value or the description.

15. The method of claim 1, further comprising:
obtaining, by the computing system comprising the one or more processor devices of the one or more computing devices, from the executing application server configured to provide the one or more services to the plurality of applications, each application being configured to interface with the application server to obtain the one or more services, a second version of the management model comprising a second plurality of resources, the second plurality of resources comprising configuration parameters used by the application server to provide at least some of the services to the plurality of applications, and comprising second relationship information that identifies relationships among the second plurality of resources, a set of the second plurality of resources comprising a key identifying a resource type, a value identifying a resource name for the resource type, and an address identifying a path from a root resource of a resource tree, a set of the second plurality of resources being capable of implementing an operation comprising a parameter;
storing, in a second version data structure, a second plurality of resource node records, a set of the second plurality of resource node records corresponding to a different one of the second plurality of resources; and
storing, in the second version data structure, a plurality of edge records, at least a portion of the plurality of edge records identifying a relationship between resource node records.

16. The method of claim 15,
wherein storing, in the first version data structure, the first plurality of resource node records further comprises:
storing, in a first graph database, the first plurality of resource node records; and
wherein storing, in the second version data structure, the second plurality of resource node records further comprises:
storing, in a second graph database, the second plurality of resource node records.

17. The method of claim 15, further comprising:
receiving, by the computing system, a request to compare two different versions of a resource;
retrieving a first version of a resource node record corresponding to the resource from the first version data structure;
retrieving a second version of the resource node record corresponding to the resource from the second version data structure;
determining differences between the first version of the resource node record and the second version of the resource node record; and
sending, by the computing system, a reply that identifies differences between the first version of the resource node record and the second version of the resource node record.

18. The method of claim 15, further comprising:
presenting, by the computing system on a display device, user interface imagery that identifies the first version of the management model and the second version of the management model;
receiving, by the computing system, user input selecting the first version of the management model;
subsequently receiving, by the computing system, a request for information about a resource;
based on the user input, accessing the first version of the management model;
accessing a node record that corresponds to the resource; and
presenting information from the node record about the resource.

19. A computing system comprising:
one or more processor devices of one or more computing devices to:
obtain, from an executing application server configured to provide one or more services to a plurality of applications, each application being configured to interface with the application server to obtain the one or more services, a first version of a management model comprising a first plurality of resources, the first plurality of resources comprising configuration parameters used by the application server to provide at least some of the services to the plurality of applications, and comprising first relationship information that identifies relationships among the first plurality of resources, a set of the first plurality of resources comprising a key identifying a resource type, a value identifying a resource name for the resource type, and an address identifying a path from a root resource of a resource tree, a set of the first plurality of resources being capable of implementing an operation comprising a parameter;
store, in a first version data structure, a first plurality of resource node records, each of the first plurality of resource node records corresponding to a different one of the first plurality of resources; and
store, in the first version data structure, a first plurality of edge records, at least a portion of the first plurality of edge records identifying a relationship between resource node records.

20. A computer program product stored on a non-transitory computer-readable storage medium and including instructions to cause one or more processor devices of one or more computing devices to:
obtain, from an executing application server to provide one or more services to a plurality of applications, each application being configured to interface with the application server to obtain the one or more services, a first version of a management model comprising a first plurality of resources, the first plurality of resources comprising configuration parameters used by the application server to provide at least some of the services to the plurality of applications, and comprising first relationship information that identifies relationships among the first plurality of resources, a set of the first plurality of resources comprising a key identifying a resource type, a value identifying a resource name for the resource type, and an address identifying a path from a root resource of a resource tree, a set of the first plurality of resources being capable of implementing an operation comprising a parameter;
store, in a first version data structure, a first plurality of resource node records, each of the first plurality of resource node records corresponding to a different one of the first plurality of resources; and
store, in the first version data structure, a first plurality of edge records, at least a portion of the first plurality of edge records identifying a relationship between resource node records.
